(19) United States
(12) Patent Application Publication
(10) Pub. No.: US 2025/0356079 A1
(43) Pub. Date: Nov. 20, 2025

(54) INFORMATION PROCESSING APPARATUS

(71) Applicant: NEC Corporation, Tokyo (JP)

(72) Inventor: Yuta IDEGUCHI, Tokyo (JP)

(73) Assignee: NEC Corporation, Tokyo (JP)

(21) Appl. No.: 19/188,155

(22) Filed: Apr. 24, 2025

(30) Foreign Application Priority Data
May 17, 2024 (JP) 2024-081178

(51) Int. Cl. G06F 30/20; G06F 111/10

(52) U.S. Cl. CPC G06F 30/20; G06F 2111/10

(57) ABSTRACT

An information processing apparatus of the present disclosure includes: a first calculating unit that calculates a flip energy change, which is an energy change when a constraint condition is satisfied and each spin flips, using an objective function of a formulated model representing energy in a combinatorial optimization problem with the constraint condition; a second calculating unit that calculates a transition energy change, which is an energy change at a time of transitioning to a next solution in the combinatorial optimization problem, based on the flip energy change; and a third calculating unit that calculates an inverse temperature used at a time of solving the optimization problem by pseudo-quantum annealing, based on the transition energy change.

### INCORPORATION BY REFERENCE

This application is based upon and claims the benefit of priority from Japanese patent application No. 2024-081178, filed on May 17, 2024, the disclosure of which is incorporated herein in its entirety by reference.

### TECHNICAL FIELD

The present disclosure relates to an information processing apparatus.

### BACKGROUND ART

A constraint-based combinatorial optimization problem is transformed into a form of a model obtained by formulating the expression of energy in the problem, and solved. For example, Patent Literature 1 describes transforming energy in a combinatorial optimization problem into the Ising model and solving by pseudo-quantum annealing.

In pseudo-quantum annealing, a search for solution is performed by calculating a change in energy when flipping a given spin, and determining whether to flip the spin in accordance with the change in energy and an inverse temperature, which is a set temperature parameter. At this time, the search for solution is performed while increasing or decreasing the inverse temperature, but since it takes time to reach the optimal solution, Patent Literature 1 describes estimating the inverse temperature in such a manner as to be able to escape from a local solution.

### CITATION LIST

### Patent Literature

[Patent Literature 1] JP 7428268

### SUMMARY OF INVENTION

### Technical Problem

However, an inverse temperature is estimated in consideration of a change in energy related to a constraint term in a constraint-based combinatorial optimization problem in the abovementioned technique described in Patent Literature 1, which cannot be applied appropriately in the case of using a solver that solves while satisfying the constraint condition. For this reason, there arises a problem that it is not possible to shorten the solution time for a constraint-based combinatorial optimization problem.

Accordingly, an object of the present disclosure is to solve the abovementioned problem that it is not possible to shorten the solution time for a constraint-based combinatorial optimization problem.

### Solution to Problem

An information processing apparatus as an aspect of the present disclosure includes: a first calculating unit that calculates a flip energy change, which is an energy change when a constraint condition is satisfied and each spin flips, using an objective function of a formulated model representing energy in a combinatorial optimization problem with the constraint condition; a second calculating unit that calculates a transition energy change, which is an energy change at a time of transitioning to a next solution in the combinatorial optimization problem, based on the flip energy change; and a third calculating unit that calculates an inverse temperature used at a time of solving the optimization problem by pseudo-quantum annealing, based on the transition energy change.

Further, an information processing method as an aspect of the present disclosure includes: calculating a flip energy change, which is an energy change when a constraint condition is satisfied and each spin flips, using an objective function of a formulated model representing energy in a combinatorial optimization problem with the constraint condition; calculating a transition energy change, which is an energy change at a time of transitioning to a next solution in the combinatorial optimization problem, based on the flip energy change; and calculating an inverse temperature used at a time of solving the optimization problem by pseudo-quantum annealing, based on the transition energy change.

Further, a program as an aspect of the present disclosure includes instructions for causing a computer to execute processes to: calculate a flip energy change, which is an energy change when a constraint condition is satisfied and each spin flips, using an objective function of a formulated model representing energy in a combinatorial optimization problem with the constraint condition; calculate a transition energy change, which is an energy change at a time of transitioning to a next solution in the combinatorial optimization problem, based on the flip energy change; and calculate an inverse temperature used at a time of solving the optimization problem by pseudo-quantum annealing, based on the transition energy change.

### Advantageous Effects of Invention

Configured as described above, the present disclosure can shorten the solution time for a constraint-based combinatorial optimization problem.

### BRIEF DESCRIPTION OF DRAWINGS

FIG. 1 is a block diagram showing an example of a configuration of an information processing apparatus according to the present disclosure.

FIG. 2 is a diagram showing an example of data related to the present disclosure.

FIG. 3 is a flowchart showing an example of processing operation of the information processing apparatus according to the present disclosure.

FIG. 4 is a block diagram showing an example of the configuration of the information processing apparatus according to the present disclosure.

FIG. 5 is a diagram showing an example of data related to the present disclosure.

FIG. 6 is a flowchart showing an example of the processing operation of the information processing apparatus according to the present disclosure.

FIG. 7 is a block diagram showing an example of a hardware configuration of the information processing apparatus according to the present disclosure.

FIG. 8 is a block diagram showing an example of the configuration of the information processing apparatus according to the present disclosure.

### EXAMPLE EMBODIMENTS

### First Example Embodiment

A first example embodiment of the present disclosure will be described with reference to the drawings. The drawings may be related to any of the example embodiments.

An information processing apparatus in the present disclosure is used for calculating an inverse temperature that is set when solving a combinatorial optimization problem with a constraint condition set in advance by pseudo-quantum annealing (simulated annealing). Here, an example of a method for solving a constraint-based combinatorial optimization problem by pseudo-quantum annealing will be described.

A constraint-based combinatorial optimization problem is a problem in which an objective function and a constraint condition are set and a solution that minimizes the objective function while satisfying the constraint condition is obtained. Then, a constraint-based combinatorial optimization problem can be transformed into, for example, a formulated model such as the Ising model and a quadratic unconstrained binary optimization (QUBO) model as shown in Formula 1 and Formula 2. At this time, a constraint-based combinatorial optimization problem can express an energy value E in the optimization problem using an objective function term (first term and second term) and a constraint condition term (third term and fourth term) as shown in Formula 1, and they can be merged into one model as shown in Formula 2.

$$E = {\sum }_{i} {\sum }_{j} {J}_{ij}^{′} {s}_{i} {s}_{j} + {\sum }_{i} {h}_{i}^{′} {s}_{i} + {\sum }_{i} {\sum }_{j} {\hat{J}}_{i j} {s}_{i} {s}_{j} + {\sum }_{i} {\hat{h}}_{i}^{′} {s}_{i} \qquad [ Formula 1 ]$$

$$E = {\sum }_{i} {\sum }_{j} {J}_{i j} {s}_{i} {s}_{j} + {\sum }_{i} {h}_{i} {s}_{i} \qquad [ Formula 2 ]$$

Here, sᵢ and sⱼ in the above formula are variables representing the states of spins sᵢ and sⱼ, and are expressed as “−1” or “1”, or as “0” or “1”. In this example embodiment, a description will be made expressing the states of the spins i and j as “0” or “1”. Note that i and j are the identification numbers of the spin s. In addition, Jᵢⱼ and J′ᵢⱼ in the above formula are weight parameters set in correspondence with each combination of the spins sᵢ and sⱼ, and represent the energy value.

Then, at the time of obtaining a spin that minimizes the energy E by pseudo-quantum annealing in the constraint-based combinatorial optimization problem described above, by flip of the state of the spin s from 0 to 1 or from 1 to 0, the solution is made to transition and searched for. At this time, in pseudo-quantum annealing, at the time of searching for the solution, it always transitions when the evaluation value of a neighborhood solution is good (small), and it may transition stochastically even when the evaluation value of a neighborhood solution is bad (large). A probability p at this time is determined by an inverse temperature β, which is the inverse of the value of a temperature parameter, as shown in Formula 3.

$$p = exp ( - Δ E * β ) \qquad [ Formula 3 ]$$

Then, when the inverse temperature is low (temperature parameter is high), the probability of transition to a solution with a bad evaluation value is higher, and it is possible to escape from a local solution, but it may be away from the optimal solution. When the inverse temperature is high (temperature parameter is low), the probability of transition to a solution with a bad evaluation value is low, and it may converge to a neighborhood local solution, and it may be impossible to escape from a local solution. Therefore, a search for solution is performed while increasing or decreasing the inverse temperature β, but since it takes time to reach the optimal solution, the inverse temperature β that makes it possible to escape from a local solution is estimated in the following manner in this example embodiment. Hereinafter, an example of a configuration and operation of an information processing apparatus 10 in this example embodiment will be described in detail.

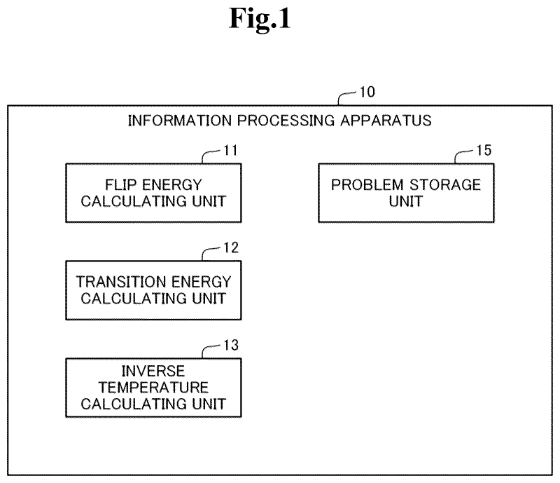

The information processing apparatus 10 is configured with one or a plurality of information processing apparatuses each including an arithmetic logic unit and a memory unit. Then, as shown in FIG. 1, the information processing apparatus 10 includes a flip energy calculating unit 11, a transition energy calculating unit 12, and an inverse temperature calculating unit 13. The respective functions of the flip energy calculating unit 11, the transition energy calculating unit 12, and the inverse temperature calculating unit 13 can be implemented by execution of a program for implementing the respective functions stored in the memory unit by the arithmetic logic unit. Moreover, the information processing apparatus 10 includes a problem storage unit 15 implemented by the memory unit.

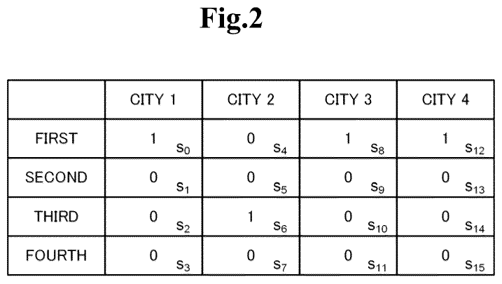

The problem storage unit 15 stores information representing a constraint-based combinatorial optimization problem to be solved. For example, in this example embodiment, a traveling salesman problem as shown in FIG. 2 will be described as an example of a constraint-based combinatorial optimization problem. A traveling salesman problem is an optimization problem to find a route with the shortest travel distance under a constraint condition that the salesman visits all cities once given the distance between each pair of cities. The example of FIG. 2 shows a case of traveling four cities (city 1 to city 4) in order (first to fourth) and represents that there are 16 spins s (s₀ to s₁₅), the salesman is preset when the state of the spin s is “1”, and the salesman is absent when the state of the spin s is “0”. Then, the energy E of the traveling salesman problem of FIG. 2 is shown by Formula 4.

$$E = {\sum }_{i} {\sum }_{j} {d}_{i j} {s}_{i} {s}_{j} + A {\sum }_{i = 0}^{3} {( {\sum }_{j = 0}^{3} {s}_{4 i + j} - 1 )}^{2} + A {\sum }_{i = 0}^{3} {( {\sum }_{j = 0}^{3} {s}_{4 j + i} - 1 )}^{2} \qquad [ Formula 4 ]$$

In Formula 4, the first term represents an objective function. That is to say, dᵢⱼ represents the distance between two cities, and the objective function represents the sum of the distances between the respective pairs of cities. Moreover, in Formula 4, the second term and the third term represent constraint terms, and represent that there is only one “1” in each row and there is only one “1” in each column in FIG. 2.

For convenience of the description in this example embodiment, the energy value E of Formula 4 will be described by Formula 5 below, which is the same as Formula 1 described above. That is to say, in Formula 5, the first term and the second term are objective functions, and the third term and the fourth term are constraint terms.

$$E = {\sum }_{i} {\sum }_{j} {J}_{ij}^{′} {s}_{i} {s}_{j} + {\sum }_{i} {h}_{i}^{′} {s}_{i} + {\sum }_{i} {\sum }_{j} {\hat{J}}_{i j} {s}_{i} {s}_{j} + {\sum }_{i} {\hat{h}}_{i}^{′} {s}_{i} \qquad [ Formula 5 ]$$

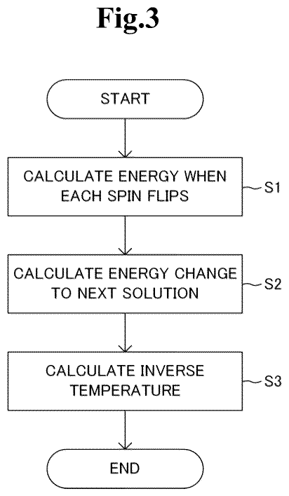

The flip energy calculating unit 11 (first calculating unit) calculates a flip energy change amount ΔE(i) representing a change in energy when each spin s satisfies a constraint condition and flips (step S1 of FIG. 3). At this time, since each spin s satisfies the constraint condition of the optimization problem and flips, the values of the constraint conditions that are the third and fourth terms of Formula 5 become “0”, and the flip energy calculating unit 11 calculates the flip energy change amount ΔE(i) of each spin s from an equation of the energy value E shown in Formula 6 including only the objective functions of the first and second terms alone. Then, Formula 6 can be expressed by Formula 7, and the flip energy change amount ΔE(i) can be expressed by Formula 8. That is to say, when the spin sᵢ flips, a change in energy varies in accordance with the state of the other spin sⱼ, so that changes in energy of all states of all the other spins sⱼ are calculated. Consequently, an energy change Eᵢ when the spin sᵢ flips can be calculated as shown in Formula 9.

$$E = {\sum }_{i} {\sum }_{j} {J}_{i j}^{′} {s}_{i} {s}_{j} + {\sum }_{i} {h}_{i}^{′} {s}_{i} \qquad [ Formula 6 ]$$

$$E = {\sum }_{i} {s}_{i} ( {\sum }_{j} {J}_{i j}^{′} {s}_{j} + {h}_{i}^{′} ) \qquad [ Formula 7 ]$$

$$\vert Δ E ( i ) \vert = {\sum }_{j} {J}_{i j}^{′} {s}_{j} + {h}_{i}^{′} \qquad [ Formula 8 ]$$

$${E}_{i} = [ {E}_{i , 0} , {E}_{i , 1} , … , ] \qquad [ Formula 9 ]$$

The transition energy calculating unit 12 (second calculating unit) calculates a transition energy change E^{flip}, which is a change in energy when transitioning to the next solution in a combination optimization problem, based on the flip energy change ΔE of each spin s (step S2 of FIG. 3). At this time, assuming a case where N^{flip1} spins flip to 1 and N^{flip0} spins flip to 0, the transition energy calculating unit calculates a transition energy change E^{flip} by Formula 10.

$${E}^{f l i p} = {\sum }_{s e l e c {t}_{i} , {selcect}_{x}}^{{N}^{flip 1}} {E}_{i , x} - {\sum }_{s e l e c {t}_{i} , {selcect}_{x}}^{{N}^{flip 0}} {E}_{i , x} \qquad [ Formula 10 ]$$

Then, the transition energy calculating unit calculates the transition energy change E^{flip} for all combinations in a case where each spin s flips to 1 or 0 by Formula 10.

The inverse temperature calculating unit 13 (third calculating unit) calculates an inverse temperature used when solving an optimization problem by pseudo-quantum annealing, based on the transition energy change E^{flip} that is a change in energy to the next solution calculated as described above (step S3 of FIG. 3). For example, the inverse temperature calculating unit 13 calculates in such a manner that an inverse temperature β is smaller as the transition energy change E^{flip} is larger, and calculates in such a manner that the inverse energy β is larger as the transition energy change E^{flip} is smaller. The inverse temperature can be calculated by the method described in Patent Literature 1. To be specific, the equation of the probability p obtained from the inverse temperature β and the energy ΔE shown in Formula 3 can be expressed by Formula 11, where the transition energy change E^{flip} is ΔE and the probability p is 1/M (M: number of spins). Therefore, the inverse temperature β can be calculated as shown in Formula 11 to Formula 12.

$$1 / M = exp ( - Δ E * β ) \qquad [ Formula 11 ]$$

$$β = ln ( M ) / Δ E \qquad [ Formula 12 ]$$

By outputting the inverse temperature β calculated as described above, the inverse temperature calculating unit 13 can set and use the inverse temperature β in the optimization processing apparatus that solves an optimization problem by quasi-quantum annealing. As a result, it is possible to inhibit a search for an appropriate value such as increasing and decreasing the value of an inverse temperature while performing a solution process, and it is possible to achieve shortening of the solution time in a constraint-based combinatorial optimization problem.

### Second Example Embodiment

Next, a second example embodiment of the present disclosure will be described with reference to the drawings. The drawings may be related to any of the example embodiments.

The information processing apparatus 10 in this example embodiment includes a similar configuration to that of the information processing apparatus 10 in the first example embodiment described above. Hereinafter, a different configuration and operation of the information processing apparatus 10 will be mainly described in detail.

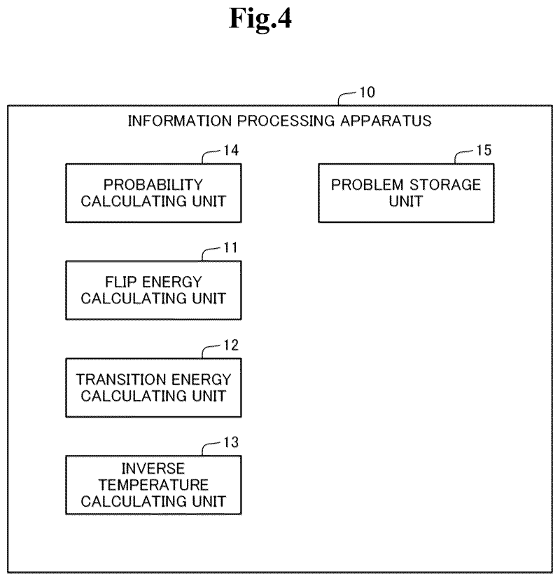

The information processing apparatus 10 is configured with one or a plurality of information processing apparatuses each including an arithmetic logic unit and a memory unit. Then, as shown in FIG. 4, the information processing apparatus 10 includes a probability calculating unit 14, the flip energy calculating unit 11, the transition energy calculating unit 12, and the inverse temperature calculating unit 13. The respective functions of the probability calculating unit 14, the flip energy calculating unit 11, the transition energy calculating unit 12, and the inverse temperature calculating unit 13 can be implemented by execution of a program for implementing the respective functions stored in the memory unit by the arithmetic logic unit. Moreover, the information processing apparatus 10 includes a problem storage unit 15 implemented by the memory unit.

The problem storage unit 15 stores information representing a constraint-based combinatorial optimization problem to be solved. In this example embodiment, as in the first example embodiment described above, information on the traveling salesman problem as shown in FIG. 2 is stored as an example of a constraint-based combinatorial optimization problem. Therefore, an energy value E in a constraint-based combinatorial optimization problem can be expressed as in Formula 13 that is the same as Formula 5. At this time, in Formula 13, the first and second terms are objective functions, and the third and fourth terms are constraint terms.

$$E = {\sum }_{i} {\sum }_{j} {J}_{ij}^{′} {s}_{i} {s}_{j} + {\sum }_{i} {h}_{i}^{′} {s}_{i} + {\sum }_{i} {\sum }_{j} {\hat{J}}_{i j} {s}_{i} {s}_{j} + {\sum }_{i} {\hat{h}}_{i}^{′} {s}_{i} \qquad [ Formula 13 ]$$

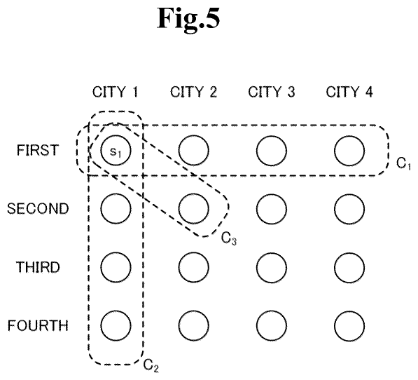

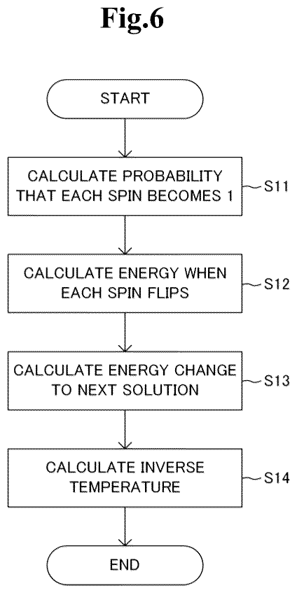

The probability calculating unit 14 (fourth calculating unit) calculates a probability that each spin s satisfies the constraint condition of the optimization problem and comes in a specific state (step S11 of FIG. 6). At this time, in this example embodiment, in a case where a plurality of constraint conditions are set in the optimization problem, the average of probabilities that the spin s comes in a specific state under each constraint condition is calculated, and it is set as the probability of the spin s. As an example, in a case where the optimization problem is a traveling salesman problem and, as shown in FIG. 5, it is the constraint condition that only one spin s is in the state of 1, that is, in the one hot state in each of regions C₁, C₂ and C₃ surrounded by dotted lines, the probability that only spin s₁ comes in the state of 1 in each of the regions C₁, C₂ and C₃ is found. In this case, the probability that the spin s₁ becomes 1 in the region C₁ is 0.25 because it is the probability that one of the four spins becomes 1. Likewise, the probability that the spin s₁ becomes 1 in the region C₂ is 0.25, and the probability that the spin s1 becomes 1 in the region C₃ is 0.5. Then, on average, a probability p₁ of the spin s₁ is obtained as (0.25+0.25+0.5)/3=0.333. The calculation of the probability described above is an example, and the probability p of each spin s may be calculated by any method.

The flip energy calculating unit 11 (first calculating unit) calculates a flip energy change amount ΔE(i) representing a change in energy when each spin s satisfies a constraint condition and flips, using the probability p calculated as described above (step S12 of FIG. 6). Also in this example embodiment, each spin s satisfies the constraint condition of the optimization problem and flips, so that the values of the constraint terms that are the third and fourth terms of Formula 13 become “0”, and the flip energy calculating unit calculates the flip energy change amount ΔE(i) of each spin s from an equation of the energy value E shown in Formula 14 including only objective functions of the first and second terms alone. Then, Formula 14 can be expressed by Formula 15, and the flip energy change amount ΔE(i) can be expressed by Formula 16.

$$E = {\sum }_{i} {\sum }_{j} {J}_{i j}^{′} {s}_{i} {s}_{j} + {\sum }_{i} {h}_{i}^{′} {s}_{i} \qquad [ Formula 14 ]$$

$$E = {\sum }_{i} {s}_{i} ( {\sum }_{j} {J}_{i j}^{′} {s}_{j} + {h}_{i}^{′} ) \qquad [ Formula 15 ]$$

$$\vert Δ E ( i ) \vert = {\sum }_{j} {J}_{i j}^{′} {s}_{j} + {h}_{i}^{′} \qquad [ Formula 16 ]$$

To be specific, when calculating the flip energy change amount ΔE(i) in a given spin sᵢ, the flip energy calculating unit 11 first estimates the number Nᵢ^{one} of the other spins sⱼ that flip to the state of 1 among the other spins sⱼ related to the spin sᵢ. At this time, the flip energy calculating unit estimates the number Nᵢ^{one} of the other spins sⱼ that become 1, using the probability pⱼ that the other spin sⱼ becomes 0 calculated as described above. As an example, the flip energy calculating unit estimates the number Nᵢ^{one} of the other spins sⱼ that become 1 by Formula 17.

$${N}_{i}^{o n e} = {\sum }_{j} {k}_{i , j {P}_{j}} {k}_{i , j} = \{ \begin{matrix}1 & {J}_{ij}^{′} \neq 0 \\ 0 & therwise\end{matrix} \qquad [ Formula 17 ]$$

Then, the flip energy calculating unit 11 sorts weights J′ᵢⱼ related to the spin sᵢ in ascending order, and calculates the sum of the number Nᵢ^{one} of the other spins sⱼ that become 1 estimated as described above. Consequently, when the number of weights related to the spin sᵢ is Nᵢ^{ref}, the number of combinations can be reduced from the number shown in Formula 18 to the number shown in Formula 19.

$${}_{{N}_{i}^{ref}} {C}_{{N}_{i}^{one}} \qquad [ Formula 18 ]$$

$${N}_{i}^{ref} - {N}_{i}^{o n e} + 1 \qquad [ Formula 19 ]$$

Consequently, it is possible to calculate an energy change Eᵢ when the spin sᵢ flips as shown by Formula 20.

$${E}_{i} = [ {E}_{i , 0} , {E}_{i , 1} , … , {E}_{i , {N}_{i}^{ref} - {N}_{i}^{one}} ] \qquad [ Formula 20 ]$$

In Formula 20, E_{i,0} is the calculated sum of Nᵢ^{one} values from the first smallest value, and E_{i,1} is the calculated sum of None values from the second smallest value. In this manner, the energy change Ei of each spin sᵢ is calculated. Then, the flip energy calculating unit 11 gathers the energies when the respective spins flip into one as shown by Formula 21. Note that N^{spin} is the number of spins.

$${E}^{o n e} = {E}_{0} \vert {E}_{1} \vert {E}_{2} \vert {E}_{3} \vert … \vert {E}_{{N}^{s p i n} - 1} \qquad [ Formula 21 ]$$

The transition energy calculating unit 12 (second calculating unit) calculates a transition energy change E^{flip}, which is a change in energy at the time of transitioning to the next solution in a combinatorial optimization problem, using the flip energy change E^{one} of each spin s calculated as described above (step S13 of FIG. 6). At this time, assuming a case where N^{flip1} spins flip to 1 and N^{flip0} spins flip to 0, the transition energy calculating unit calculates the transition energy change E^{flip} by Formula 22.

$${E}^{f l i p} = {N}^{flip 1} {E}^{o n e} - {N}^{f l i p 0} {E}^{o n e} \qquad [ Formula 22 ]$$

Here, in order to speed up the calculation, Formula 22 is simplified as shown by Formula 23 by considering only a case of N^{flip1}=N^{flip0}=N^{flip}

$${E}^{f l i p} = {N}^{f l i p} ( {E}^{o n e} - {E}^{o n e} ) \qquad [ Formula 23 ]$$

At this time, as an example, by calculating all E^{flip} in a case where N^{flip} is about 1 to 10, an energy change to the next solution is obtained. It is an example to set N^{flip} to about 1 to 10, and all E^{flip} may be calculated with N^{flip} being any number. Further, as described above, N^{flip1}=N^{flip0} is an example, and E^{flip} may be calculated using Formula 22 by setting N^{flip1} and N^{flip0} to different numbers.

The inverse temperature calculating unit 13 (third calculating unit) calculates an inverse temperature used when solving an optimization problem by pseudo-quantum annealing, based on the transition energy change E^{flip} that is a change in energy to the next solution calculated as described above (step S14 of FIG. 6). The calculation of the inverse temperature can be performed in the same manner as in the example embodiment described above.

By outputting an inverse temperature β calculated as described above, the inverse temperature calculating unit 13 can set and use the inverse temperature β in the optimization processing apparatus that solves an optimization problem by quasi-quantum annealing. As a result, it is possible to inhibit a search for an appropriate value by increasing and decreasing the value of an inverse temperature while performing a solution process, and it is possible to achieve shortening of the solution time in a constraint-based combinatorial optimization problem.

### Third Example Embodiment

Next, a third example embodiment of the present disclosure will be described with reference to the drawings. This example embodiment shows the overview of the information processing apparatus and the like described in the above example embodiments. The drawings may be related to any of the example embodiments.

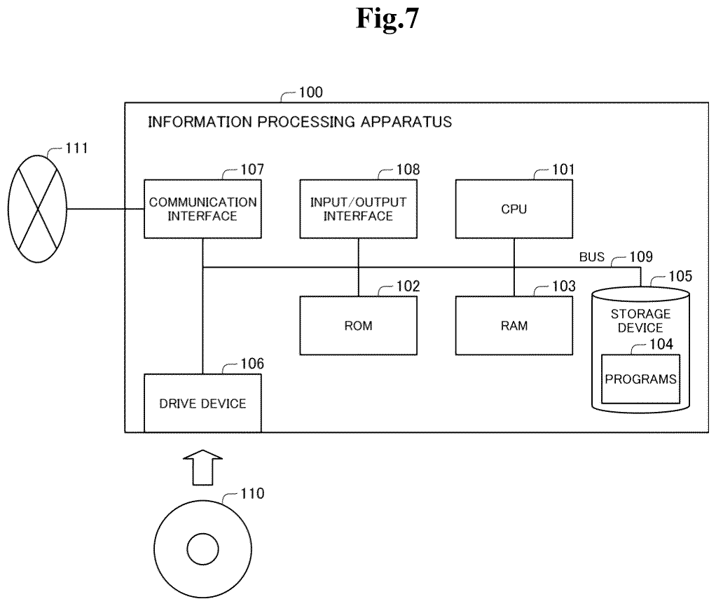

First, a hardware configuration of an information processing apparatus 100 in the present disclosure will be described. The information processing apparatus 100 is configured with a general information processing apparatus and, as an example, as shown in FIG. 7, has the following hardware configuration including:
a CPU (Central Processing Unit) 101 (arithmetic logic unit);
a ROM (Read Only Memory) 102 (memory unit);
a RAM (Random Access Memory) 103 (memory unit);
programs 104 loaded into the RAM 103;
a storage device 105 storing the programs 104;
a drive device 106 that performs reading from and writing into a storage medium 110 external to the information processing apparatus;
a communication interface 107 connected to a communication network 111 external to the information processing apparatus;
an input/output interface 108 that performs input/output of data; and
a bus 109 connecting the components.

FIG. 7 shows an example of the hardware configuration of the information processing apparatus serving as the information processing apparatus 100, and the hardware configuration of the information processing apparatus is not limited to the abovementioned case. For example, the information processing apparatus may be configured with part of the abovementioned configuration, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination of these, instead of the abovementioned CPU.

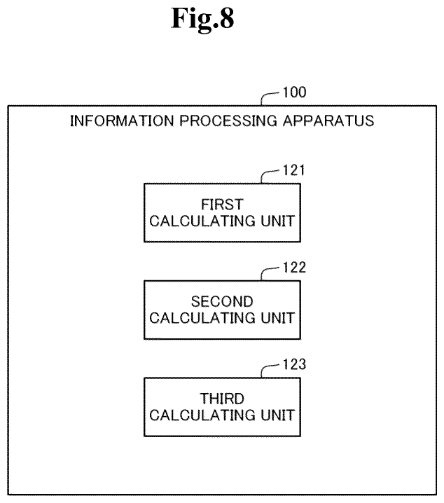

Then, the information processing apparatus 100 can construct and include a first calculating unit 121, a second calculating unit 122, and a third calculating unit 123 shown in FIG. 8 by acquisition and execution of the programs 104 by the CPU 101. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the first calculating unit 121, the second calculating unit 122, and the third calculating unit 123 described above may be constructed using dedicated electronic circuit for implementing such means.

The first calculating unit 121 calculates a flip energy change, which is a change in energy when a constraint condition is satisfied and each spin flips, using an objective function of a formulated model representing energy in a constraint-based combinatorial optimization problem. The second calculating unit 122 calculates a transition energy change, which is a change in energy at the time of transitioning to the next solution in the combinatorial optimization problem, based on the flip energy change. The third calculating unit 123 calculates an inverse temperature used when solving the optimization problem by pseudo-quantum annealing, based on the transition energy change.

With the configuration as described above, the present disclosure can calculate an inverse temperature that can be set when solving by pseudo-quantum annealing, from information of a constraint-based combinatorial optimization problem. As a result, it is possible to achieve shortening of the solution time by solving the optimization problem using the calculated inverse temperature.

At least one or more functions of the functions of the first calculating unit 121, the second calculating unit 122, and the third calculating unit 123 described above may be executed by an information processing apparatus installed and connected anywhere on a network, that is, may be executed by so-called cloud computing.

Further, the abovementioned programs can be stored using various types of non-transitory computer-readable mediums and provided to a computer. The non-transitory computer-readable medium includes various types of tangible storage mediums. Examples of non-transitory computer-readable medium include magnetic recording medium (e.g., flexible disk, magnetic tape, hard disk drive), magneto-optical recording medium (e.g., magneto-optical disk), read only memory (CD-ROM), CD-R, CD-R/W, semiconductor memory (e.g., mask ROM, programmable ROM, erasable PROM, flash ROM, random access memory (RAM)). In addition, a program may be provided to a computer by various types of temporary computer-readable medium. Examples of temporary computer-readable medium include electrical signals, optical signals, and electromagnetic waves. The temporary computer-readable medium may provide a program to the computer via a wired communication channel, such as an electric wire and an optical fiber, or a wireless communication channel.

Although the present disclosure has been described above with reference to example embodiments, the present disclosure is not limited to the example embodiments described above. The configuration and details of the present disclosure can be changed in a variety of ways that those skilled in the art can understand within the scope of the present disclosure. Then, each of the example embodiments described above can be combined with the other example embodiment as necessary.

### SUPPLEMENTARY NOTES

The whole or part of the example embodiments disclosed above can be described as the following supplementary notes. Hereinafter, the overview of the configurations of an information processing apparatus, an information processing method, and a program in the present disclosure will be described. However, the present disclosure is not limited to the configurations described in the following supplementary notes.

All or some of the configurations described in Supplementary Notes 2 to 8 dependent on Supplementary Note 1 described above and the functions by such configurations may be dependent on other Supplementary Notes 9 and 10 by the same dependence as Supplementary Notes 2 to 8. Furthermore, not limited to Supplementary Notes 1, 9 and 10, within the scope of the example embodiments described above, all or some of the configurations described as supplementary notes and functions by such configurations may be dependent on hardware, software, various recording means for recording software, or system.

### Supplementary Note 1

An information processing apparatus comprising:
a first calculating unit that calculates a flip energy change, which is an energy change when a constraint condition is satisfied and each spin flips, using an objective function of a formulated model representing energy in a combinatorial optimization problem with the constraint condition;
a second calculating unit that calculates a transition energy change, which is an energy change at a time of transitioning to a next solution in the combinatorial optimization problem, based on the flip energy change; and
a third calculating unit that calculates an inverse temperature used at a time of solving the optimization problem by pseudo-quantum annealing, based on the transition energy change.

### Supplementary Note 2

The information processing apparatus according to supplementary note 1, comprising
a fourth calculating unit that calculates a probability that the constraint condition is satisfied and each spin comes in a specific state, wherein
the first calculating unit calculates the flip energy change of each spin based on the probability.

### Supplementary Note 3

The information processing apparatus according to supplementary note 2, wherein
the first calculating unit estimates, based on the probability of an other spin with respect to a given spin, a number of the other spin that flip to the specific state among the other spin, and calculates the flip energy change based on the estimated number of the other spin.

### Supplementary Note 4

The information processing apparatus according to supplementary note 3, wherein
the first calculating unit estimates the number of the other spin based on a weight parameter for a combination of two spins set in the model and on the probability.

### Supplementary Note 4.1

The information processing apparatus according to supplementary note 4, wherein
the first calculating unit estimates the number of the other spin based on a number of a weight parameter whose value is not zero for a combination of two spins set in the model and on the probability.

### Supplementary Note 5

The information processing apparatus according to supplementary note 3, wherein
the first calculating unit calculates the flip energy change based on a value of, among a weight parameter for a combination of two spins set in the model, the weight parameter of the estimated number of the other spin.

### Supplementary Note 5.1

The information processing apparatus according to supplementary note 5, wherein
the first calculating unit calculates the flip energy change based on a value of, among a weight parameter whose value is not zero for a combination of two spins set in the model, the weight parameter of the estimated number of the other spin.

### Supplementary Note 6

The information processing apparatus according to supplementary note 1, wherein
the second calculating unit calculates the transition energy change based on a number of a spin that flips to a specific state and on a number of a spin that flips to another state different from the specific state.

### Supplementary Note 7

The information processing apparatus according to supplementary note 6, wherein
the second calculating unit calculates the transition energy change based on a value obtained by subtracting a sum of the flip energy change of the spin that flips to the another state from a sum of the flip energy change of the spin that flips to the specific state.

### Supplementary Note 8

The information processing apparatus according to supplementary note 7, wherein
the second calculating unit calculates the transition energy change in a case where the number of the spin that flips to the specific state and a number of a spin that flips to a different value from the specific state are the same.

### Supplementary Note 9

An information processing method comprising:
calculating a flip energy change, which is an energy change when a constraint condition is satisfied and each spin flips, using an objective function of a formulated model representing energy in a combinatorial optimization problem with the constraint condition;
calculating a transition energy change, which is an energy change at a time of transitioning to a next solution in the combinatorial optimization problem, based on the flip energy change; and
calculating an inverse temperature used at a time of solving the optimization problem by pseudo-quantum annealing, based on the transition energy change.

### Supplementary Note 9.1

The information processing method according to supplementary note 9, comprising:
calculating a probability that the constraint condition is satisfied and each spin comes in a specific state; and
calculating the flip energy change of each spin based on the probability.

### Supplementary Note 10

A program comprising instructions for causing a computer to execute processes to:
calculate a flip energy change, which is an energy change when a constraint condition is satisfied and each spin flips, using an objective function of a formulated model representing energy in a combinatorial optimization problem with the constraint condition;
calculate a transition energy change, which is an energy change at a time of transitioning to a next solution in the combinatorial optimization problem, based on the flip energy change; and
calculate an inverse temperature used at a time of solving the optimization problem by pseudo-quantum annealing, based on the transition energy change.

### Supplementary Note 10.1

The program according to supplementary note 10, further comprising instructions for causing the computer to execute processes to:
calculate a probability that the constraint condition is satisfied and each spin comes in a specific state; and
calculate the flip energy change of each spin based on the probability.

### REFERENCE SIGNS LIST

10 information processing apparatus
11 flip energy calculating unit
12 transition energy calculating unit
13 inverse temperature calculating unit
14 probability calculating unit
15 problem storage unit
100 information processing apparatus
101 CPU
102 ROM
103 RAM
104 programs
105 storage device
106 drive device
107 communication interface
108 input/output interface
109 bus
110 storage medium
111 communication network
121 first calculating unit
122 second calculating unit
123 third calculation unit

1. An information processing apparatus comprising:
at least one memory storing processing instructions; and
at least one processor configured to execute the processing instructions to:
calculate a flip energy change, which is an energy change when a constraint condition is satisfied and each spin flips, using an objective function of a formulated model representing energy in a combinatorial optimization problem with the constraint condition;
calculate a transition energy change, which is an energy change at a time of transitioning to a next solution in the combinatorial optimization problem, based on the flip energy change; and
calculate an inverse temperature used at a time of solving the optimization problem by pseudo-quantum annealing, based on the transition energy change.

2. The information processing apparatus according to claim 1, wherein the at least one processor is configured to execute the processing instructions to:
calculate a probability that the constraint condition is satisfied and each spin comes in a specific state; and
calculate the flip energy change of each spin based on the probability.

3. The information processing apparatus according to claim 2, wherein the at least one processor is configured to execute the processing instructions to
estimate, based on the probability of an other spin with respect to a given spin, a number of the other spin that flip to the specific state among the other spin, and calculate the flip energy change based on the estimated number of the other spin.

4. The information processing apparatus according to claim 3, wherein the at least one processor is configured to execute the processing instructions to
estimate the number of the other spin based on a weight parameter for a combination of two spins set in the model and on the probability.

5. The information processing apparatus according to claim 4, wherein the at least one processor is configured to execute the processing instructions to
estimate the number of the other spin based on a number of a weight parameter whose value is not zero for a combination of two spins set in the model and on the probability.

6. The information processing apparatus according to claim 3, wherein the at least one processor is configured to execute the processing instructions to
calculate the flip energy change based on a value of, among a weight parameter for a combination of two spins set in the model, the weight parameter of the estimated number of the other spin.

7. The information processing apparatus according to claim 5, wherein the at least one processor is configured to execute the processing instructions to
calculate the flip energy change based on a value of, among a weight parameter whose value is not zero for a combination of two spins set in the model, the weight parameter of the estimated number of the other spin.

8. The information processing apparatus according to claim 1, wherein the at least one processor is configured to execute the processing instructions to
calculate the transition energy change based on a number of a spin that flips to a specific state and on a number of a spin that flips to another state different from the specific state.

9. The information processing apparatus according to claim 8, wherein the at least one processor is configured to execute the processing instructions to
calculate the transition energy change based on a value obtained by subtracting a sum of the flip energy change of the spin that flips to the another state from a sum of the flip energy change of the spin that flips to the specific state.

10. The information processing apparatus according to claim 9, wherein the at least one processor is configured to execute the processing instructions to
calculate the transition energy change in a case where the number of the spin that flips to the specific state and a number of a spin that flips to a different value from the specific state are the same.

11. An information processing method comprising:
calculating a flip energy change, which is an energy change when a constraint condition is satisfied and each spin flips, using an objective function of a formulated model representing energy in a combinatorial optimization problem with the constraint condition;
calculating a transition energy change, which is an energy change at a time of transitioning to a next solution in the combinatorial optimization problem, based on the flip energy change; and
calculating an inverse temperature used at a time of solving the optimization problem by pseudo-quantum annealing, based on the transition energy change.

12. The information processing method according to claim 11, comprising:
calculating a probability that the constraint condition is satisfied and each spin comes in a specific state; and
calculating the flip energy change of each spin based on the probability.

13. A non-transitory computer-readable storage medium storing a program, the program comprising instructions for causing a computer to execute processes to:
calculate a flip energy change, which is an energy change when a constraint condition is satisfied and each spin flips, using an objective function of a formulated model representing energy in a combinatorial optimization problem with the constraint condition;
calculate a transition energy change, which is an energy change at a time of transitioning to a next solution in the combinatorial optimization problem, based on the flip energy change; and
calculate an inverse temperature used at a time of solving the optimization problem by pseudo-quantum annealing, based on the transition energy change.
